(19) United States
(12) Patent Application Publication
(10) Pub. No.: US 2025/0006950 A1
(43) Pub. Date: Jan. 2, 2025

(54) NONAQUEOUS ELECTROLYTIC SOLUTION FOR POWER STORAGE DEVICE, AND POWER STORAGE DEVICE

(71) Applicant: Panasonic Intellectual Property Management Co., Ltd., Kadoma-shi, Osaka (JP)

(72) Inventor: Satoshi Nishitani, OSAKA FU (JP)

(73) Assignee: Panasonic Intellectual Property Management Co., Ltd., Kadoma-shi, Osaka (JP)

(21) Appl. No.: 18/709,675

(22) PCT Filed: Aug. 25, 2022
(86) PCT No.: PCT/JP2022/031990

§ 371 Date: May 13, 2024

(30) Foreign Application Priority Data
Nov. 22, 2021 (JP) 2021-189319

(51) Int. Cl. H01M 6/16; H01M 4/06; H01M 4/50

(52) U.S. Cl. CPC H01M 6/168; H01M 4/06; H01M 4/50; H01M 2300/0025

(57) ABSTRACT

Disclosed is a nonaqueous liquid electrolyte including a solute, a nonaqueous solvent, an isocyanate component, and a phenol component. The nonaqueous liquid electrolyte is used in a power storage device.

### TECHNICAL FIELD

The present disclosure relates to a nonaqueous liquid electrolyte for a power storage device, and a power storage device.

### BACKGROUND ART

Power storage devices, such as lithium primary batteries, lithium-ion secondary batteries, and lithium secondary batteries (sometimes called lithium-metal secondary batteries and so on) have been more and more often used outdoors. Therefore, power storage devices are required to maintain stable characteristics even when exposed to various environments, such as high temperature environment or extremely low temperature environment below freezing.

Patent Literature 1 proposes a nonaqueous organic liquid electrolyte for a lithium primary battery including manganese dioxide as a positive electrode active material and lithium metal or a lithium alloy as a negative electrode active material, in which an organic compound having a chain structure and belonging to a dicarboxylic acid ester is added as an additive to a base liquid electrolyte composed of an organic solvent and a supporting salt.

Patent Literature 2 proposes a nonaqueous liquid electrolyte including a nonaqueous organic solvent and a lithium salt dissolved therein. The nonaqueous liquid electrolyte contains a chain carboxylic acid ester in an amount of 5 to 70 mass % relative to the mass of the nonaqueous liquid electrolyte, and further contains a compound having two or more isocyanate groups.

Patent Literature 3 proposes a nonaqueous liquid electrolyte including a nonaqueous organic solvent and a lithium salt dissolved therein. The nonaqueous liquid electrolyte contains at least one or more chain ethers selected from a group of compounds represented by a specific formula in a total amount of 20 to 80 mass % relative to the mass of the nonaqueous liquid electrolyte, further contains alkane sulfonic anhydride represented by a specific formula, and further contains a cyclic carbonate having an unsaturated bond or a fluorine atom.

### CITATION LIST

### Patent Literature

Patent Literature 1: Japanese Laid-Open Patent Publication No. 2016-46027
Patent Literature 2: Japanese Laid-Open Patent Publication No. 2013-175369
Patent Literature 3: Japanese Laid-Open Patent Publication No. 2013-211224

### SUMMARY OF INVENTION

### Technical Problem

In a power storage device, the output voltage may drop in low temperature environment in some cases. When the output voltage of the power storage device drops, the equipment equipped with the power storage device may fail to operate properly.

### Solution to Problem

A first aspect of the present disclosure relates to a nonaqueous liquid electrolyte for use in a power storage device, including:
a solute;
a nonaqueous solvent;
an isocyanate component; and
a phenol component.

A second aspect of the present disclosure relates to a power storage device, including: a pair of electrodes; and a nonaqueous liquid electrolyte, wherein the nonaqueous liquid electrolyte includes
a solute,
a nonaqueous solvent,
an isocyanate component, and
a phenol component.

### Advantageous Effects of Invention

It is possible to provide a nonaqueous liquid electrolyte for a power storage device and a power storage device that can ensure high output voltage in low temperature environment.

### BRIEF DESCRIPTION OF DRAWING

FIG. 1 A partial cross-sectional front view of a power storage device according to an embodiment of the present disclosure.

### DESCRIPTION OF EMBODIMENTS

While the novel features of the invention are set forth particularly in the appended claims, the invention, both as to organization and content, will be better understood and appreciated, along with other objects and features thereof, from the following detailed description taken in conjunction with the drawings.

The output of a power storage device is greatly influenced by the progress of the battery reactions at the interfaces between the electrodes and the nonaqueous liquid electrolyte. Especially in low temperature environment, the diffusivity of ions in the nonaqueous liquid electrolyte decreases, making it difficult for the battery reactions to proceed at the interfaces between the electrodes and the nonaqueous liquid electrolyte. In low temperature environment, therefore, the output characteristics of the power storage device tend to deteriorate, causing a significant drop in output voltage. When the drop in output voltage is significant, it may fail to secure sufficient voltage to operate an equipment equipped with the power storage device. The power storage device includes, for example, batteries and capacitors that utilize nonaqueous liquid electrolyte. The power storage device may be, for example, a nonaqueous liquid electrolyte battery or a capacitor that uses lithium ions as charge carriers (hereinafter sometimes, carrier ions). Examples of such power storage devices include lithium primary batteries, lithium-ion secondary batteries, lithium secondary batteries, and lithium-ion capacitors.

In recent years, there has been an accelerated trend toward ICT (Information and Communication Technology), including DX (Digital Transformation) etc. An example of equipment that has been getting popularity ahead in ICT is a smart meter. The smart meter is an equipment that transmits data regarding the consumed quantity of gas or electricity. The equipment utilized for such purposes is required to continue operating for a long time without maintenance. For example, a lithium primary battery is, because of its high energy density and little self-discharge, suitable for long term use.

The equipment utilized for the purposes as above is often used outdoors, and often exposed to various environments, such as high temperature environment and low temperature environment. Therefore, power storage devices, such as lithium primary batteries, to be equipped in such equipment are required to have a stable output voltage even when exposed to harsh environments, such as high temperature or low temperature.

When a nonaqueous liquid electrolyte containing an isocyanate component is used in a power storage device, the high reaction activity of the isocyanate group acts on the electrode surface to form a film derived from the isocyanate component. The film protects the electrode surface, and therefore, side reactions between the electrodes and the nonaqueous solvent etc. are considered to be suppressed, but the resistance increases. The increase in resistance is presumably because, due to a rapid growth of the film, a film with large thickness is formed on the electrode during battery assembly or even in the early stage after assembly, too. Since such a film inhibits charge-discharge reactions, the effect of improving output in low temperature environment is limited.

From the viewpoint of the above, (1) the nonaqueous liquid electrolyte according to the first aspect of the present disclosure includes a solute, a nonaqueous solvent, an isocyanate component, and a phenol component. Such a nonaqueous liquid electrolyte is used in a power storage device.

The present disclosure also encompasses (2) an electricity storage device including a pair of electrodes and a nonaqueous liquid electrolyte. In the electricity storage device, the nonaqueous liquid electrolyte includes a solute, a nonaqueous solvent, an isocyanate component, and a phenol component.

In the present disclosure, an isocyanate component and a phenol component are used in combination in a nonaqueous liquid electrolyte, so that the reaction between the isocyanate component and the phenol component can be utilized, to suppress rapid film formation on the electrode surface. On the electrode surface, a film with excellent film quality derived from both the isocyanate and phenol components is formed, and presumably because of this, while the effect of protecting the electrode surface is ensured, the resistance of the film can be suppressed low, and high ion conductivity can be ensured. With a film with excellent film quality formed on the electrode, high output voltage of the power storage device can be ensured even in low temperature environment of, for example, −20° C. or lower (e.g., −30° C.). Phenolic hydroxy groups correspond to tertiary alcohols, and due to steric hindrance of the aromatic ring, the reactivity thereof toward isocyanate groups is low, as compared to primary alcohols or secondary alcohols. The reaction between the phenol component and the isocyanate component therefore proceeds relatively slowly. It is considered therefore that by using the phenol component, a protective film with excellent film quality can be formed while a certain degree of reactivity of the isocyanate group on the electrode is ensured.

Note that as compared to when using a nonaqueous liquid electrolyte (liquid electrolyte B1) containing neither an isocyanate component nor a phenol component, when using a nonaqueous liquid electrolyte (liquid electrolyte B2) containing an isocyanate component and not containing a phenol component, the effect is slight, although the output voltage in low temperature environment improves. On the other hand, the ability of the phenol component to form a film on the electrode is considered to be low, and when using a nonaqueous liquid electrolyte (liquid electrolyte B3) containing a phenol component and not containing an isocyanate component, the output voltage is low in low temperature environment as compared to when using the liquid electrolyte B1. In other words, it can be said that the phenol component itself does not have the effect of improving the output voltage in low temperature environment. From the forgoing, it can be predicted that even though an isocyanate component and a phenol component are combined, the effect of enhancing the output voltage in low temperature environment will be barely obtained. However, when an isocyanate component and a phenol component are actually combined, the output voltage greatly improves in low temperature environment. This is presumably because, due to the appropriate interaction between the isocyanate component and the phenol component, a protective film with excellent film quality derived from both components is formed on the electrode surface, synergistically improving the output voltage.

In general, when a power storage device is exposed to high temperature environment, the reaction between the nonaqueous liquid electrolyte and the electrodes proceeds vigorously, which facilitates the growth of a film on the electrode, so that the resistance of the film tend to be high. When the power storage device is used in low temperature environment after the film with high resistance has been formed on the electrode in high temperature environment, the output voltage will drop significantly. Since the nonaqueous liquid electrolyte of the present disclosure uses an isocyanate component and a phenol component in combination, the resistance of the film formed when the power storage device is exposed to high temperature environment (e.g., during storage at high temperature) can be suppressed low, and the high ion conductivity of the film is likely to be ensured. Thus, it is possible to suppress the drop in output voltage of the power storage device when the power storage device is used in low temperature environment after exposed to high temperature environment (e.g., after storage at high temperature).

(3) In the above (1) or (2), the mass ratio of the phenol component to the isocyanate component (=phenol component/isocyanate component) may be 2×10⁻³ or less.

(4) In any one of the above (1) to (3), the concentration of the phenol component in the nonaqueous liquid electrolyte may be 10 ppm or less on a mass basis.

(5) In any one of the above (1) to (4), the concentration of the isocyanate component in the nonaqueous liquid electrolyte may be 10 mass % or less.

(6) In any one of the above (1) to (5), the isocyanate component may include an isocyanate compound having two or more isocyanate groups.

(7) In any one of the above (1) to (6), the isocyanate component may include an isocyanate compound including a ring structure.

(8) In any one of the above (1) to (7), the phenol component may include a phenol compound having an aromatic ring, at least one phenolic hydroxy group directly bonded to the aromatic ring, and at least one selected from the group consisting of a hydrocarbon group and an alkoxy group each directly bonded to the aromatic ring.

(9) In the above (8), the phenol compound may have at least an alkyl group, as the hydrocarbon group.

(10) In any one of the above (1) to (9), the solute may include a lithium salt.

(11) In any one of the above (1) to (10), the power storage device may be a lithium primary battery including a pair of electrodes. One of the pair of electrodes may include at least one of metal lithium and a lithium alloy, and the other electrode may include a positive electrode mixture containing manganese dioxide.

In the following, the nonaqueous liquid electrolyte and the power storage device of the present disclosure, including the above (1) to (11), will be more specifically described. At least one of the above (1) to (11) and at least one of the elements described below may be combined, as long as no technical contradiction arises.

### [Nonaqueous Liquid Electrolyte]

### (Isocyanate Component)

The isocyanate component may be, for example, an isocyanate compound having an isocyanate group. As the isocyanate compound, a compound soluble in a nonaqueous solvent is usually used.

The isocyanate compound may be either one of an isocyanate compound having one isocyanate group (sometimes referred to as a monoisocyanate compound) and an isocyanate compound having two or more isocyanate groups (sometimes referred to as a polyisocyanate compound). With a polyisocyanate compound, a portion of the isocyanate groups reacts with the phenol component, and the remaining portion of the isocyanate groups acts on the electrode, and thus, a protective film derived from the isocyanate component and the phenol component is likely to be formed on the electrode surface. It is preferable therefore that the isocyanate component includes at least a polyisocyanate compound. A polyisocyanate compound may be used in combination with a monoisocyanate compound.

The upper limit of the number of isocyanate groups in the polyisocyanate compound is, for example, 5 or less, and may be 4 or less, or 3 or less. The isocyanate component may include at least one selected from the group consisting of a diisocyanate compounds having two isocyanate groups and a triisocyanate compounds having three isocyanate groups (in particular, a diisocyanate compound). In the present disclosure, even when the concentration of the phenol component in the nonaqueous liquid electrolyte is extremely low, the output voltage in low temperature environment can be improved. Therefore, when at least one selected from the group consisting of a diisocyanate compound and a triisocyanate compound (in particular, a diisocyanate compound) is used, the reaction with the phenol component and the action on the electrode are likely to be well-balanced, making it easy to form a protective film with excellent film quality. For example, the proportion of the diisocyanate compound in the isocyanate component may be, for example, 50 mass % or more, and may be 75 mass % or more, or 90 mass % or more. The proportion of the diisocyanate compound in the isocyanate component is 100 mass % or less. The isocyanate compound may be a chain compound, and may include a ring structure. The chain isocyanate compound may be straight or branched. The ring structure may be a hydrocarbon ring, and may be a heterocycle. The ring structure may be an aromatic ring, and may be a non-aromatic ring.

The aromatic ring may be, for example, 6- to 20-membered, and may be 6- to 10-membered. The aromatic ring encompasses a structure (sometimes referred to as a bisarene structure) in which a plurality of aromatic rings are linked to each other by a single bond or via a first linking group (an alkylene group (including an alkylidene group), an ether bond (—O—), etc.), such as biphenyl, bisphenyl alkane, and bisphenyl ether. The ring structure including an aromatic ring encompasses a ring structure having an aromatic ring and a non-aromatic ring condensed to the aromatic ring. The non-aromatic ring encompasses an aliphatic hydrocarbon ring, a non-aromatic heterocycle, and the like. In the ring structure, the non-aromatic ring may be a bridged ring. The aliphatic hydrocarbon ring encompasses a ring structure corresponding to a hydrogenated product of the bisarene structure.

In terms of their relatively inexpensive prices and easy availability and the unlikeliness to cause side reactions, an isocyanate compound including an aromatic or aliphatic hydrocarbon ring, a chain isocyanate compound, and the like may also be used.

In the isocyanate compound including a ring structure, the isocyanate group may be directly bonded to the ring or may be bonded to the ring via a second linking group. Examples of the second linking group include an alkylene group (including an alkylidene group), an oxydialkylene group, and a —NH—R— group (R is an alkylene group). In the —NH—R— group, the isocyanate group is bonded to R.

The alkylene of the first and the second linking group, each alkylene group constituting the oxydialkylene group of the second linking group, and the alkylene group represented by R each have, for example, 1 to 12 carbon atoms, and may each have 1 to 10 or 1 to 6 carbon atoms.

In the present specification, the heterocycle is a ring containing a hetero atom (e.g., at least one selected from the group consisting of nitrogen atom, oxygen atom, and sulfur atom), as a constituent atom of the ring. The heterocycle may be aromatic or non-aromatic. With an aromatic isocyanate compound, due to the resonance structure of the aromatic ring, the reactivity of the isocyanate group is enhanced, and the speed of film formation tends to be increased. Therefore, the isocyanate component preferably includes at least one selected from the group consisting of a chain isocyanate compound (an aliphatic isocyanate compound etc.) and an isocyanate compound having an aliphatic ring (an aliphatic hydrocarbon ring etc.).

With an isocyanate compound including a ring structure, as compared to a chain isocyanate compound, higher output voltage tends to be obtained in low temperature environment. Therefore, it is also preferable that the isocyanate component contains, at least, an isocyanate compound including a ring structure. The isocyanate component may include an isocyanate compound including a ring structure, and a chain isocyanate compound. Preferred as the isocyanate compound including a ring structure is, as described above, at least one selected from isocyanate compounds having an aliphatic ring (an aliphatic hydrocarbon ring etc.). The proportion of the isocyanate compound including a ring structure (e.g., an aliphatic ring, such as an aliphatic hydrocarbon ring) in the isocyanate component may be 30 mass % or more or 50 mass % or more, and may be 70 mass % or more. The proportion of the isocyanate compound including a ring structure (e.g., an aliphatic ring, such as an aliphatic hydrocarbon ring) in the isocyanate component is 100 mass % or less.

The isocyanate compound encompasses an isocyanate compound having a substituent. The isocyanate compound may have a substituent in the main chain, may have in the side chain, and may have in the ring structure. Examples of such a substituent include a hydrocarbon group (a saturated hydrocarbon group, such as alkyl group), an alkoxy group, an alkoxycarbonyl group, an oxo group (═O), and a halogen atom (fluorine atom, chlorine atom, etc.). The alkyl group and the alkoxy group may each have 1 to 6 carbon atoms, may each have 1 to 4 carbon atoms, and may each have 1 or 2 carbon atoms. The alkoxycarbonyl group may have 2 to 7 atoms, may have 2 to 5 carbon atoms, and may have 2 to 4 carbon atoms. The isocyanate compound may have one substituent, and may have two or more substituents. When the isocyanate compound has two or more substituents, at least two substituents may be the same or all may be different.

The monoisocyanate compound is exemplified by, for example, a chain monoisocyanate compound (alkyl isocyanate, alkoxycarbonyl isocyanate, etc.), a monoisocyanate compound including an aliphatic hydrocarbon ring (cyclohexyl isocyanate, cyclohexylmethyl isocyanate, etc.), and a monoisocyanate compound including an aromatic hydrocarbon ring (phenyl isocyanate, fluorophenyl isocyanate, benzyl isocyanate, etc.). Examples of the alkyl isocyanate include an alkyl isocyanate in which the alkyl has 1 to 10 carbon atoms (e.g., methyl isocyanate, ethyl isocyanate, propyl isocyanate, butyl isocyanate, pentyl isocyanate, hexyl isocyanate, heptyl isocyanate, octyl isocyanate), and a monoisocyanate compound including a heterocycle. Examples of the alkoxycarbonyl isocyanate include an alkoxycarbonyl isocyanate (e.g., methoxycarbonyl isocyanate) in which the alkoxycarbonyl has 2 to 10 (e.g., 2 to 6) carbon atoms. The diisocyanate compound is exemplified by, for example, a chain diisocyanate compound (e.g., alkylene diisocyanate, alkylene diisocyanate having an alkoxycarbonyl group (lysine diisocyanate, etc.)), a diisocyanate compound including an aliphatic hydrocarbon ring, and a diisocyanate compound including an aromatic hydrocarbon ring. Examples of the alkylene diisocyanate include an alkylene diisocyanate in which the alkylene has 2 to 12 (preferably 4 to 10) carbon atoms (e.g., tetramethylene diisocyanate, pentamethylene diisocyanate, hexamethylene diisocyanate, peptamethylene diisocyanate, octamethylene diisocyanate, 2,2,4-trimethylhexamethylene diisocyanate, 2,4,4-trimethylhexamethylene diisocyanate). Examples of the diisocyanate compound including an aliphatic hydrocarbon ring include an isophorone diisocyanate, a bisisocyanatoalkylcyclohexane [e.g., 1,2-bis(isocyanatomethyl)cyclohexane, 1,3-bis(isocyanatomethyl)cyclohexane, 1,4-bis(isocyanatomethyl)cyclohexane, 1,2-bis(isocyanatoethyl)cyclohexane, 1,3-bis(isocyanatoethyl)cyclohexane, 1,4-bis(isocyanatoethyl)cyclohexane], dicyclohexylmethane-4,4′-diisocyanate, bicyclo[2.2.1]heptane-2,5-diylbis(methylisocyanate), and bicyclo[2.2.1]heptane-2,6-diylbis(methylisocyanate). Examples of the diisocyanate compound including an aromatic hydrocarbon ring include a diisocyanatoarene [e.g., phenylene diisocyanate, toluene diisocyanate (2,4-tolylene diisocyanate, 2,6-tolylene diisocyanate, etc.), diisocyanatonaphthalene], a diisocyanatoalkylarene (e.g., xylylene diisocyanate), and an isocyanatobisarene [e.g., bis(4-isocyanatophenyl) methane, 4,4′-diisocyanato-3,3′-dimethylbiphenyl]. The triisocyanate compound is exemplified by, for example, a chain triisocyanate compound (1,6,11-triisocyanatoundecane, lysine triisocyanate, tris(isocyanatohexyl) biuret, etc.), a triisocyanate compound including an aliphatic hydrocarbon ring, and a triisocyanate compound including a non-aromatic heterocycle. Examples of the triisocyanate compound including a non-aromatic heterocycle include a triisocyanate compound having a backbone derived from isocyanuric acid (a compound in which an isocyanatoalkyl group is bonded to the nitrogen atom of isocyanuric acid). Note that the alkyl group in the isocyanatoalkyl group corresponds to the alkylene group in the second linking group. Specific examples of such compounds include 1,3,5-tris(6-isocyanatohex-1-yl)-1,3,5-triazine-2,4,6 (1H,3H,5H)-trione, 1,3,5-tris(6-isocyanatotetra-1-yl)-1,3,5-triazine-2,4,6 (1H,3H,5H)-trione, 1,3,5-tris(6-isocyanatopent-1-yl)-1,3,5-triazine-2,4,6 (1H,3H,5H)-trione, 1,3,5-tris(6-isocyanatotetra-1-yl)-1,3,5-triazine-2,4,6 (1H,3H,5H)-trione, and 1,3,5-tris(6-isocyanatohept-1-yl)-1,3,5-triazine-2,4,6 (1H,3H,5H)-trione.

The isocyanate component may include one kind of isocyanate compound, or may include two or more kinds of isocyanate compounds.

The concentration of the isocyanate component in the nonaqueous liquid electrolyte is, for example, 15 mass % or less, and may be 12 mass % or less. From the viewpoint of ensuring higher output voltage in low temperature environment, the concentration of the isocyanate component is preferably 11 mass % or less or 10 mass % or less. When the concentration of the isocyanate component is within such a range, higher output voltage in low temperature environment after storage at high temperature is likely to be ensured. The concentration of the isocyanate component in the nonaqueous liquid electrolyte may be 0.1 mass % or more, and may be 0.2 mass % or more. From the viewpoint of securing higher output voltage in low temperature environment, the concentration of the isocyanate component in the nonaqueous liquid electrolyte is preferably 0.5 mass % or more or 1 mass % or more, and may be 2 mass % or more or 3 mass % or more. These upper and lower limits can be combined in any combination. For example, the concentration of the isocyanate component in the nonaqueous liquid electrolyte may be 0.1 mass % or more (or 0.2 mass % or more) and 15 mass % or less, may be 0.5 mass % or more and 11 mass % or less (or 10 mass % or less), and may be 2 mass % or more and 11 mass % or less (or 10 mass % or less). Such a concentration of the isocyanate component is a value (in other words, an initial value) in the nonaqueous liquid electrolyte used for assembling a power storage device. The concentration of the isocyanate component determined with respect to the nonaqueous liquid electrolyte sampled from the power storage device may be in the above range. In the power storage device, since the isocyanate component is consumed for film formation, the concentration of the isocyanate component in the nonaqueous liquid electrolyte changes, for example, during storage or with use. Therefore, when analyzing with respect to a nonaqueous liquid electrolyte sampled from the power storage device, it suffices as long as the isocyanate component remains in the nonaqueous liquid electrolyte at a concentration equal to or higher than the detection limit. Accordingly, the upper limit of the concentration of the isocyanate component may be in the above range, and the lower limit thereof may be equal to or higher than the detection limit.

Qualitative and quantitative analysis of the isocyanate component can be performed using a nonaqueous liquid electrolyte, by gas chromatography-mass spectrometry (GC-MS) under the conditions below.
Apparatus: GC (7890B, available from Agilent Technologies, Inc.), MS (5977B, available from Agilent Technologies, Inc.)
Column: Agilent J&W HP-1 (1 μm×60 m), available from Agilent Technologies, Inc.
Column temperature: Raising temperature at 5° C./min. from 50° C. to 110° C. and holding at 110° C. for 12 minutes. Raising temperature at 5° C./min. from 110° C. to 250° C. and holding at 250° C. for 7 minutes. Raising temperature at 10° C./min. from 250° C. to 300° C. and holding at 300° C. for 20 minutes.
Split ratio: 1/50
Linear velocity: 25.3 cm/sec.
Inlet temperature: 270° C.
Interface temperature: 230° C.
Injection amount: 0.5 μL
Mass range: m/z=30 to 400

### (Phenol Component)

The phenol component may be, for example, a phenol compound including an aromatic ring and at least one phenolic hydroxy group directly bonded to the aromatic ring (in other words, an aromatic hydroxy compound). As the phenol compound, a compound soluble in a nonaqueous solvent is usually used.

The aromatic ring may be a non-aromatic heterocycle, but is preferably an aromatic hydrocarbon ring. The aromatic hydrocarbon ring encompasses an arene ring, a bisarene ring, and the like. Examples of the arene ring include an arene ring with 6 to 20 carbon atoms (benzene ring, naphthalene ring, anthracene ring, phenanthrene ring, etc.). Examples of the bisarene ring include a ring structure in which the above arene rings (esp., benzene rings, naphthalene rings, etc.) are linked to each other by a single bond or via a third linking group. The third linking group is selected, for example, from the groups exemplified for the second linking group. The aromatic ring encompasses a condensed ring of an aromatic ring and a non-aromatic ring (alicyclic hydrocarbon ring, heterocycle, etc.). From the viewpoint of ensuring appropriate reactivity with the isocyanate component, the phenol component preferably includes a phenol compound having a benzene ring as an aromatic ring. In other words, the phenol component preferably includes phenol or a derivative thereof (phenol having a substituent, etc.), as a phenol compound.

The phenol compound may have one phenolic hydroxy group, or may have two or more phenolic hydroxy groups. Although depending on the number of ring members of the aromatic ring, the number of phenolic hydroxy groups may be 4 or less, or 3 or less. The phenol component may include a phenol compound having one or two phenolic hydroxy groups.

The phenol compound may have a substituent directly bonded to the aromatic ring. Examples of such a substituent include a hydrocarbon group, an alkoxy group, and an alkoxycarbonyl group. Preferred as the hydrocarbon group are an aliphatic hydrocarbon group (alkyl or cycloalkyl, etc.) having no ethylenically unsaturated bond, an aralkyl group such as a phenylalkyl group, and the like. The alkyl group and the alkoxy group each have, for example, 1 to 10 carbon atoms, and may each have 1 to 6 or 1 to 5 carbon atoms. The alkoxycarbonyl group has, for example, 2 to 12 carbon atoms, and may have 2 to 7 carbon atoms. The cycloalkyl group has, for example, 5 to 10 carbon atoms, and may have 5 to 8 carbon atoms. Specific examples of the alkyl group include methyl group, ethyl group, propyl group, isopropyl group, n-butyl group, isobutyl group, sec-butyl group, tert-butyl group, neopentyl group, sec-pentyl group, 3-pentyl group, and tert-pentyl group. Specific examples of the alkoxy group include methoxy group, ethoxy group, n-propoxy group, isopropoxy group, n-butoxy group, and tert-butoxy group. Specific examples of the alkoxycarbonyl group include methoxycarbonyl group, ethoxycarbonyl group, a propoxycarbonyl group, and a butoxycarbonyl group. Examples of the aralkyl group include a phenylalkyl group in which the alkyl has 1 to 4 carbon atoms (benzyl group, phenethyl group, α-methylbenzyl group, α,α-dimethylbenzyl group, etc.). The phenol component preferably includes a phenol compound having an aromatic ring, at least one phenolic hydroxy group directly bonded to the aromatic ring, and at least one selected from the group consisting of a hydrocarbon group and an alkoxy group each directly bonded to the aromatic ring. When the phenol component includes such a phenol compound, appropriate reactivity with the isocyanate component is likely to be obtained, and a protective film with excellent film quality is likely to be formed on the electrode surface. The proportion of such a phenol compound in the phenol component is, for example, 50 mass % or more, and may be 75 mass % or more. The proportion of the phenol compound shown above in the phenol component is 100 mass % or less. It is preferable that the above phenol compound has at least an alkyl group, as a hydrocarbon group.

The phenol compound may have, for example, a hindered group, such as a hindered alkyl group, and a phenylalkyl group in which the alkyl is a branched alkyl. Examples of the hindered alkyl group include a hindered alkyl group having 4 to 10 or 4 to 6 carbon atoms (tert-butyl, tert-pentyl, etc.). Examples of the phenylalkyl group include a phenylalkyl group in which the alkyl is a branched alkyl group having 2 to 4 carbon atoms (α-methylbenzyl, α,α-dimethylbenzyl, etc.). The phenol compound may have a hindered group and another substituent (e.g., at least one selected from the group consisting of a straight chain alkyl group and an alkoxy group).

A preferable phenol compound is represented, for example, by the following formula (1).

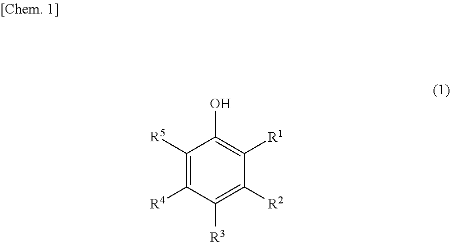

(In the formula, R¹ to R⁵ are each independently a hydrogen atom, a hydroxy group, or a substituent.)

The substituent in the formula (1) corresponds to the above-mentioned substituent. At least two of R¹ to R⁵ may be the same or all may be different. At least one of R¹ to R⁵ is preferably a substituent (a substituent selected from the group consisting of an alkyl group and an alkoxy group). In particular, it is preferable that at least one of R¹ to R⁵ is a hindered alkyl group. Of the remaining four of R¹ to R⁵, at least one may be at least one selected from the group consisting of a straight chain alkyl group and an alkoxy group. The number of carbon atoms in the straight chain alkyl group can be selected from the range of the number of carbon atoms described for the alkyl group of the substituent, and is preferably 1 to 4, and may be 1 to 3. The straight chain alkyl group may be at least one of a methyl group and an ethyl group. The number of carbon atoms in the alkoxy group can be selected from the range of the number of carbon atoms described for the alkoxy group of the substituent, and is preferably 1 to 4, and may be 1 to 3. The alkoxy group may be at least one of a methoxy group and an ethoxy group. In formula (1), the number of hydroxy groups is, for example, 1 to 4, may be 1 to 3, or may be 1 or 2.

As specific examples of the phenol compound, for example, a monophenol compound having one phenolic hydroxy group [e.g., dibutylhydroxytoluene (also known as 2,6-di-tert-butyl-p-cresol), butylhydroxyanisole (2-tert-butyl-4-methoxyphenol, 3-tert-butyl-4-methoxyphenol, or a mixture thereof), mono-, di- or tri-(α-methylbenzyl) phenol, sesamol, etc.], and a phenol compound having two or more phenolic hydroxy groups (a bisphenol compound, a polyphenol compound having a plurality of hydroxy groups in one aromatic ring, etc.) are exemplified. Examples of the bisphenol compound include 2,2′-methylenebis(4-methyl-6-tert-butylphenol), and 4,4′-butylidenebis(3-methyl-6-tert-butylphenol). Examples of the polyphenol compound include hydroquinone, resorcinol, catechol, pyrogallol, 2,5-di-tert-butylhydroquinone, 2,5-di-tert-amylhydroquinone, and propyl gallate.

The phenol component may include one kind of phenol compound, or may include two or more kinds of phenol compounds.

From the viewpoint that appropriate reactivity with the isocyanate component is likely to be obtained, and a protective film with excellent film quality is likely to be formed on the electrode surface, the phenol component preferably includes at least a monophenol compound. As such a monophenol compound, specifically, a monophenol compound in which the aromatic ring is a benzene ring is preferred, and a monophenol compound in which each of R¹ to R⁵ in the formula (1) is a hydrogen atom or a substituent is particularly preferred. The proportion of the monophenol compound in the phenol component is, for example, 30 mass % or more, may be 50 mass % or more, or may be 75 mass % or more. The proportion of the monophenol compound in the phenol component is 100 mass % or less.

Even when contained in the nonaqueous liquid electrolyte at a quite low concentration, the phenol component can act on the isocyanate component, so that a protective film with excellent film quality is formed on the electrode surface. The concentration of the phenol component in the nonaqueous liquid electrolyte is, for example, 200 ppm or less, and may be 150 ppm or less, on a mass basis. From the viewpoint of ensuring higher output voltage in low temperature environment, the concentration of the phenol component is, on a mass basis, preferably 30 ppm or less or 20 ppm or less, more preferably 10 ppm or less, and may be 8 ppm or less. When the concentration of the phenol component is within such a range, higher output voltage in low temperature environment is likely to be ensured after storage at high temperature. The concentration of the phenol component in the nonaqueous liquid electrolyte may be 0.001 ppm or more, or 0.01 ppm or more, on a mass basis. These upper and lower limits can be combined in any combination. For example, the concentration of the phenol component in the nonaqueous liquid electrolyte is, on a mass basis, 0.001 ppm or more and 200 ppm or less (or 150 ppm or less), 0.001 ppm or more and 10 ppm or less (or 8 ppm or less), or 0.01 ppm or more and 10 ppm or less (or 8 ppm or less). Such a concentration of the phenol component is a value (in other words, an initial value) in the nonaqueous liquid electrolyte used for assembling a power storage device. The concentration of the phenol component determined with respect to the nonaqueous liquid electrolyte sampled from the power storage device may be in the above range. In the power storage device, since the phenol component is consumed together with the isocyanate component for film formation, the concentration of the phenol component in the nonaqueous liquid electrolyte changes, for example, during storage or with use. Therefore, when analyzing with respect to a nonaqueous liquid electrolyte sampled from the power storage device, it suffices as long as the phenol component remains in the nonaqueous liquid electrolyte at a concentration equal to or higher than the detection limit. Accordingly, the upper limit of the concentration of the phenol component may be in the above range, and the lower limit thereof may be equal to or higher than the detection limit.

The mass ratio of the phenol component to the isocyanate component (=phenol component/isocyanate component) is 2×10⁻³ or less, and may be 1.5×10⁻³ or less. From the viewpoint of securing higher output voltage in low temperature environment, the phenol component/isocyanate component mass ratio is preferably 1×10⁻³ or less, more preferably 0.7×10⁻³ or less, or 0.5×10⁻³ or less. The phenol component/isocyanate component mass ratio may be 0.3×10⁻³ or less. In this case, higher output voltage in low temperature environment after storage at high temperature storage, too, is likely to be ensured. The phenol component/isocyanate component mass ratio may be, for example, 0.001×10⁻³ or more, and may be 0.002×10⁻³ or more. These upper and lower limits can be combined in any combination. The phenol component/isocyanate component mass ratio may be, for example, 0.001×10⁻³ or more and 2×10⁻³ or less (or 1.5×10⁻³ or less), 0.001×10⁻³ or more and 1×10⁻³ (or 0.5×10⁻³ or less), or 0.001×10⁻³ or more and 0.3×10⁻³ or less.

Qualitative and quantitative analysis of the phenol component can be performed using a nonaqueous liquid electrolyte, by GC-MS under the similar conditions to those in the analysis of the isocyanate component.

### (Nonaqueous Solvent)

Examples of the nonaqueous solvent include ethers, esters (carboxylic acid esters, etc.), and carbonic acid esters. These may be chain compounds or cyclic compounds. Examples of chain ethers include dimethyl ether and 1,2-dimethoxyethane (DME). Examples of cyclic ethers include 1,3-dioxolane, 4-methyl-1,3-dioxolane, tetrahydrofuran, and 2-methyltetrahydrofuran. Examples of chain carboxylic acid esters include formate esters (ethyl formate, etc.), acetate esters(methyl acetate, ethyl acetate, propyl acetate, etc.), and propionate esters (methyl propionate, ethyl propionate, methyl fluoropropionate, etc.). Examples of the cyclic carboxylic acid esters include γ-butyrolactone, and γ-valerolactone. Examples of chain carbonic acid esters include diethyl carbonate, ethyl methyl carbonate, and dimethyl carbonate. Examples of the cyclic carbonic acid esters include propylene carbonate (PC), and ethylene carbonate (EC). The nonaqueous liquid electrolyte may contain the nonaqueous solvent singly, or in combination of two or more kinds.

From the viewpoint of improving the discharge characteristics of the power storage device, it is preferable that the nonaqueous solvent includes a cyclic carbonic acid ester which has a high boiling point, and a chain ether which exhibits low viscosity at low temperature. The cyclic carbonic acid ester preferably includes at least one selected from the group consisting of PC and EC. The chain ether preferably includes, for example, DME.

### (Solute)

Examples of the solute include salts of cations (carrier ions) which act as charge carriers in the nonaqueous liquid electrolyte and anions which are counter ions of the cations. For example, in a power storage device (lithium primary battery, lithium-ion secondary battery, lithium secondary battery, lithium-ion capacitor, etc.) in which lithium ions act as carrier ions, a lithium salt is used as the solute. The solute of the nonaqueous liquid electrolyte may include a lithium salt.

Examples of the lithium salt include LiClO₄, LiBF₄, LiPF₆, LiRaSO₃ (LiCF₃SO₃, etc.), LiFSO₃, imide salts (LiN(SO₂R^{b})(SO₂R^{c}), LiN(FSO₂)₂, etc.), LiC(SO₂R^{d})(SO₂R^{e})(SO₂R^{f}), LiPO₂F₂, and oxalate complex salts. R^{a} to R^{f} are each independently a fluorinated alkyl group. The fluorinated alkyl group has, for example, 1 to 12 carbon atoms, and may have 1 to 6 or 1 to 4 carbon atoms. R^{b} and R^{e} may be the same (e.g., LiN(CF₃SO₂)₂, LiN(C₂FsSO₂)₂) or different (e.g., LiN(CF₃SO₂) (C₄F₉SO₂)). At least two of R^{d} to R^{f} may be the same, or all may be different. Examples of the oxalate complex salt include lithium bisoxalate borate (LiB(C₂O₄)₂), LiBF₂(C₂O₄), LiPF₄(C₂O₄), and LiPF₂(C₂O₄)₂. Furthermore, as the lithium salt, LiAlCl₄, LiAlF₄, LiAsF₆, LiSbF₆, LiTaF₆, LiNbF₆, LiSiF₆, LICH₃BF₃, LiCN, LiSCN, LiCF₃CO₂, LiB₁₀Cl₁₀, LiNO₃, LiNO₂, lithium lower aliphatic carboxylate, lithium halide (LiCl, etc.), and borates, such as lithium bis(1,2-benzenediolate(2—)—O,O′) borate may also be used. The nonaqueous liquid electrolyte may contain the lithium salt singly, or in combination of two or more kinds. The lithium salt is selected depending on, for example, the type of the power storage device, the components contained in the electrode, and the like.

### (Others)

The concentration of the solute (or carrier ions) in the nonaqueous liquid electrolyte may be, for example, 0.1 mol/L or more and 3.5 mol/L or less. The concentration of the solute is selected depending on, for example, the type, the capacity or capacitance, etc. of the power storage device. For example, in a lithium primary battery, the concentration of the solute may be in the above range, and may be 0.2 mol/L or more and 2.0 mol/L or less.

The nonaqueous liquid electrolyte may contain, as necessary, an additive other than the isocyanate component and the phenol component. Examples of the additive include propane sultone, propene sultone, ethylene sulfate, tristrimethylsilyl phosphite, tristrimethylsilyl phosphate, vinylene carbonate, fluoroethylene carbonate, vinyl ethylene carbonate, adiponitrile, and succinonitrile. The total concentration of such additives contained in the nonaqueous liquid electrolyte is, for example, 5 mol/L or less. The total concentration of the additives may be 0.003 mol/L or more. Note that the nonaqueous liquid electrolyte, even when containing no alkane sulfonic anhydride or containing alkane sulfonic anhydride at a concentration of less than 0.001 mass %, can ensure high output voltage. The alkane sulfonic anhydride encompasses, for example, alkane sulfonic anhydride that may have a fluorine atom, and alkane disulfonic anhydride that may have a fluorine atom.

Depending on the type of the power storage device, the nonaqueous liquid electrolyte may be, as necessary, a gel electrolyte with no fluidity which is a composite of a gelling agent or matrix material and a nonaqueous liquid electrolyte.

### [Power Storage Device]

The power storage device includes a pair of electrodes and a nonaqueous liquid electrolyte. The above nonaqueous liquid electrolyte is used as the nonaqueous liquid electrolyte. Among the configurations of the components of the power storage device, configurations other than that of the nonaqueous liquid electrolyte will be more specifically described below.

One of the pair of electrodes is capable of electrochemically dissolving or releasing carrier ions (lithium ions, etc.), and the other is capable of electrochemically depositing or absorbing carrier ions (lithium ions, etc.). In the present specification, the case of being capable of absorbing carrier ions encompasses also the case of being capable of adsorbing carrier ions. In a secondary battery or a capacitor, each electrode is capable of electrochemically dissolving and depositing carrier ions, or electrochemically releasing and absorbing (or desorbing and adsorbing) carrier ions. Each electrode may contain an active material having such a function.

The isocyanate component has a tendency to act on the active material or the conductive agent contained in the electrode, to form a film. Especially when the electrode contains at least one selected from the group consisting of lithium (Li) element, silicon (Si) element, and a carbonaceous material, the isocyanate component contained in the nonaqueous liquid electrolyte is likely to act on the Li element, Si element, or carbonaceous material in the electrode, to form a film with excellent film quality derived from the isocyanate component and the phenol component. When the electrode contains an element of a polyvalent metal with an oxidation number of 2 or more (at least one selected from the group consisting of manganese (Mn), nickel (Ni), and cobalt (Co), etc.), the isocyanate group acts on these elements contained in the electrode, so that the protection effect is likely to be obtained. Therefore, the effect of suppressing the drop in output voltage in low temperature environment when using the above-mentioned nonaqueous liquid electrolyte can be remarkably obtained especially in: a power storage device using an electrode containing at least one element selected from the group consisting of Li element, Si element, and a carbonaceous material; a power storage device using an electrode containing at least one element selected from the group consisting of Mn, Ni, and Co; and a power storage device in which one of the pair of electrodes contains at least one selected from the group consisting of Li element, Si element, and a carbonaceous material, and the other electrode contains at least one selected from the group consisting of Mn, Ni, and Co. Examples of the carbonaceous material include a graphitic material, carbon black, and activated carbon. Examples of the power storage device using such electrodes include a lithium primary battery, a lithium-ion secondary battery, a lithium secondary battery, and a lithium-ion capacitor. The nonaqueous liquid electrolyte of the present disclosure is particularly suitable for use in these power storage devices. Note that, in a lithium secondary battery, although the negative electrode contains only a current collector in the initial stage in some cases, the isocyanate component acts on the metal lithium deposited on the current collector during charging, to form a film with excellent film quality derived from the isocyanate component and the phenol component.

### (One of Electrodes)

In the power storage device, one of the pair of electrodes may be, for example, a negative electrode. The other electrode may be, for example, a positive electrode. The configuration of each electrode is determined depending on, for example, the type of the power storage device.

### (Negative Electrode)

In a lithium primary battery, the negative electrode contains metal lithium or a lithium alloy, and may contain both metal lithium and a lithium metal. A composite of metal lithium and a lithium alloy may also be used.

The lithium alloy may contain an element, such as aluminum, tin, silicon, magnesium, indium, lead, and zinc, in addition to lithium. Examples of the lithium alloy include Li—Al alloy, Li—Sn alloy, Li—Ni—Si alloy, Li—Pb alloy, Li—Mg alloy, Li—Zn alloy, Li—In alloy, and Li—Al—Mg alloy. From the viewpoint of ensuring the discharge capacity and stabilizing the internal resistance, the content of the metal element(s) other than lithium in the lithium alloy may be 0.05 mass % or more and 15 mass % or less.

The metal lithium, the lithium alloy, or the composite thereof is molded into a desired shape and thickness, depending on the shape, the dimensions, the standard performance, etc. of the lithium primary battery.

In the case of a coin-shaped battery, the negative electrode may be formed by punching a hoop-like metal lithium, lithium alloy, or the like into a disk shape. In the case of a cylindrical battery, the negative electrode may be a sheet of metal lithium, lithium alloy, or the like. The sheet is obtained, for example, by extrusion molding.

In each of the lithium-ion secondary battery and the lithium-ion capacitor, the negative electrode includes a negative electrode active material capable of absorbing and releasing lithium ions, or capable of dissolving or depositing lithium ions. The negative electrode may include a negative electrode current collector holding a negative electrode active material. The negative electrode may include, for example, a negative electrode mixture containing a negative electrode active material and a negative electrode current collector holding the negative electrode mixture. Examples of the negative electrode active material include lithium metal, a lithium alloy, a carbonaceous material (graphitic material, soft carbon, hard carbon, amorphous carbon, etc.), a Si-containing material (Si simple substance, Si alloy, Si compound such as oxide, nitride and carbide, etc.), and a Sn-containing material (Sn simple substance, Sn alloy, Sn compound, etc.). The negative electrode may contain the negative electrode active material singly, or in combination of two or more kinds. From the viewpoint that a film with excellent film quality derived from the isocyanate component and the phenol component is likely to be formed, a negative electrode including a negative electrode active material containing at least one selected from the group consisting of Li element, Si element (Si-containing material etc.), and a carbonaceous material may be used. The negative electrode mixture contains, in addition to the negative electrode active material, a binder (fluorocarbon resin, olefin resin, polyamide resin, polyimide resin, acrylic resin, rubbery polymer, etc.), a thickener (carboxymethylcellulose or its salt, etc.), a conductive agent (carbon black, carbon fiber, etc.), and the like can be used. The negative electrode can be formed by, for example, applying a paste containing materials of the negative electrode mixture onto the negative electrode current collector. The negative electrode may be formed by allowing a negative electrode active material to deposit on a negative electrode current collector.

In a lithium secondary battery, the negative electrode includes a current collector. As the current collector, a conductive sheet made of a conductive material other than lithium metal and lithium alloys may be used. On a surface of the current collector, at least one of a negative electrode mixture layer and a layer containing lithium (sometimes referred to as a foundation layer) may be formed. The negative electrode mixture layer is formed, for example, by applying a paste containing a negative electrode active material onto at least part of the surface of the negative electrode current collector. The foundation layer is a layer provided in advance and containing metal lithium or a lithium alloy. The lithium alloy may contain, in addition to lithium, for example, at least one element selected from the group consisting of aluminum, magnesium, indium, and zinc. From the viewpoint that a film with excellent film quality derived from the isocyanate component and the phenol component is likely to be formed, a negative electrode including a foundation layer containing lithium may be used.

### (Positive Electrode)

The positive electrode includes a positive electrode mixture. The positive electrode may include a positive electrode mixture and a positive electrode current collector holding the positive electrode mixture. The positive electrode mixture contains a positive electrode active material. The positive electrode mixture may further contain a binder, a conductive agent, and the like.

In a lithium primary battery, the positive electrode active material includes, for example, manganese dioxide. A positive electrode containing manganese dioxide as a positive electrode active material develops a relatively high voltage and is excellent in pulse discharge characteristics. Manganese dioxide may be in a mixed crystal state including a plurality of types of crystal states. The positive electrode may contain a manganese oxide other than manganese dioxide. Examples of the manganese oxide other than manganese dioxide include MnO, Mn₃O₄, Mn₂O₃, and Mn₂O₇. It suffices as long as the major component (e.g., 50 mass % or more) of the manganese oxide contained in the positive electrode is manganese dioxide.

The manganese dioxide contained in the positive electrode may be partially doped with lithium. When the amount of lithium doped is small, high capacity can be ensured. Manganese dioxide and a manganese dioxide doped with a small amount of lithium can be expressed by LiₓMnO₂, where 0≤x≤0.05. Manganese dioxide also encompasses a manganese oxide expressed by such a formula. It suffices as long as the average composition of the whole manganese oxide contained in the positive electrode is LiₓMnO₂, where 0≤x≤0.05. The ratio x of Li is 0.05 or less in the initial stage of discharge of the lithium primary battery. The ratio x of Li increases as the discharge of the lithium primary battery proceeds. The oxidation number of the manganese contained in the manganese dioxide is theoretically 4, but as for the average oxidation number of manganese, somewhat increase or decrease from 4 is permissible.

The positive electrode can include, in addition to manganese dioxide, another positive active material used in lithium primary batteries. Examples of the other positive electrode active material include fluorinated graphite. The proportion of the manganese dioxide in the whole positive electrode active material is preferably 90 mass % or more.

Examples of the binder include fluorocarbon resin, rubber particles, and acrylic resin.

Examples of the conductive agent include a conductive carbonaceous material. Examples of the conductive carbonaceous material include natural graphite, artificial graphite, carbon black, and carbon fibers.

The material for the positive electrode current collector may be, for example, stainless steel, aluminum, titanium, and the like.

In the case of a coin-shaped battery, the positive electrode may be constituted by attaching a ring-shaped positive electrode current collector with an L-shaped cross section to a positive electrode mixture pellet, or the positive electrode may be constituted only of a positive electrode mixture pellet. The positive electrode mixture pellet can be obtained by, for example, compression molding a wet positive-electrode mixture prepared by adding an appropriate amount of water to a positive electrode active material and additives, followed by drying.

In the case of a cylindrical battery, a positive electrode including a sheet of positive electrode current collector and a positive electrode mixture layer held on the positive electrode current collector can be used. As the sheet of positive electrode current collector, metal foil may be used, or a current collector with pores may be used. Examples of the current collector with pores include expanded metal, net, and punched metal. The positive electrode mixture layer can be obtained by, for example, applying the aforementioned wet positive-electrode mixture onto a surface of a sheet of positive electrode current collector or packing it into the positive electrode current collector, applying a pressure thereto in the thickness direction, followed by drying.

In a lithium-ion secondary battery, as the positive electrode active material, for example, a composite oxide containing lithium and a transition metal can be used. Examples of the transition metal include Ni, Co, and Mn. Examples of the composite oxide include LiₐCoO₂, LiₐNiO₂, LiₐMnO₂, LiₐCO_{b1}Ni_{1-b1}O₂, LiₐCo_{b1}M_{1-b1}O_{c1}, LiₐNi_{1-b1}M_{b1}O_{c1}, LiₐMn₂O₄, and LiₐMn_{2-b1}M_{b1}O₄. Here, a=0 to 1.2, b1=0 to 0.9, and c1=2.0 to 2.3. M is at least one selected from the group consisting of Na, Mg, Sc, Y, Mn, Fe, Co, Ni, Cu, Zn, Al, Cr, Pb, Sb, and B. Note that the value a indicating the molar ratio of lithium increases or decreases during charging and discharging. The composite oxide may be LiₐNi_{b2}M_{1-b2}O₂, where 0<a≤1.2, 0.3≤b2≤1, and M is at least one selected from the group consisting of Mn, Co, and Al. The positive electrode active material may be included singly, or in combination of two or more kinds. From the viewpoint that a film with excellent film quality derived from the isocyanate component and the phenol component is likely to be formed, a positive electrode including a positive electrode active material containing a polyvalent metal (esp., at least one selected from the group consisting of Mn, Ni, and Co) may be used.

In a lithium secondary battery, as the positive electrode active material, for example, a lithium-containing transition metal oxide, a transition metal fluoride, a polyanion, a fluorinated polyanion, and a transition metal sulfide can be used. Examples of the transition metal element contained in the lithium-containing transition metal oxide include at least one selected from the group consisting of Sc, Ti, V, Cr, Mn, Fe, Co, Ni, Cu, Y, Zr, and W. From the viewpoint that a film with excellent film quality derived from the isocyanate component and the phenol component is likely to be formed, the lithium-containing transition metal oxide may contain, as the transition metal element, at least one selected from the group consisting of Mn, Ni, and Co. The lithium-containing transition metal oxide may contain a typical metal (e.g., at least one selected from the group consisting of Mg, Al, Ca, Zn, Ga, Ge, Sn, Sb, Pb, Bi, etc. (esp., at least Al)).

In a lithium-ion capacitor, the positive electrode includes, for example, a carbonaceous material serving as an active material, as an essential component, and may also include a binder, a conductive agent, and the like, as optional components. As the carbonaceous material, for example, activated carbon, carbon nanotubes, graphite, graphene, and the like can be used.

Examples of the binder and the conductive agent used in the positive electrode of each of the lithium-ion secondary battery, lithium secondary battery, and lithium-ion capacitor include those exemplified for the lithium primary battery. In the case of these power storage devices, too, the positive electrode can be prepared similarly to in the case of the lithium primary battery. For example, the positive electrode is produced by applying a paste or slurry containing the components of positive electrode mixture onto a surface of a positive electrode current collector, and then drying and compressing the applied film.

### (Separator)

The power storage device may include a separator interposed between a pair of electrodes. As the separator, for example, a nonwoven fabric, a microporous film, or a laminate thereof, and the like can be used. The thickness of the separator is, for example, 5 μm or more and 100 μm or less.

The nonwoven fabric is constituted of fibers containing, for example, polypropylene, polyphenylene sulfide, polybutylene terephthalate, and the like. The microporous film includes, for example, a polyolefin resin, such as polyethylene, polypropylene, and ethylene-propylene copolymer.

### (Others)

The structure of the power storage device is not limited to a particular one. The structure may be selected depending on the type of the power storage device. For example, the power storage device may be coin-shaped, which is configured by laminating a disc-shaped positive electrode and a disc-shaped negative electrode with a separator interposed therebetween. The power storage device may be cylindrically shaped, which includes an electrode group configured by spirally winding a belt-like positive electrode and a belt-like negative electrode with a separator interposed therebetween.

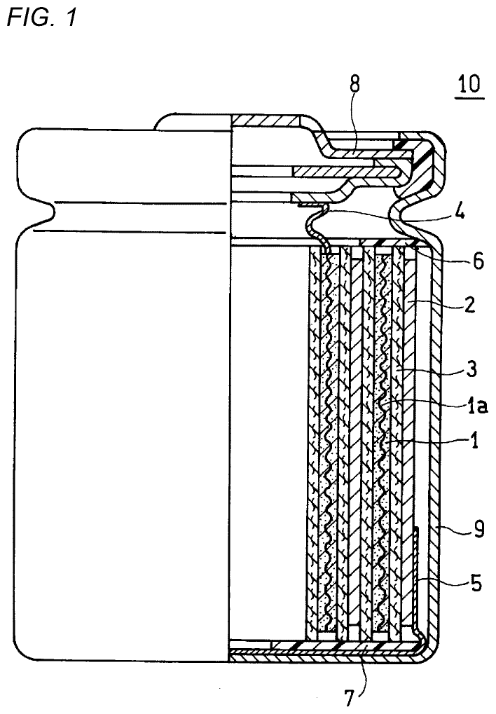

FIG. 1 is a partial cross-sectional front view of a cylindrical power storage device according to one embodiment. In a power storage device 10, an electrode group formed by winding a positive electrode 1 and a negative electrode 2, with a separator 3 interposed therebetween, is housed in a battery case 9 together with a nonaqueous liquid electrolyte (not shown). A sealing plate 8 is attached to the opening of the battery case 9. A positive electrode lead 4 connected to a current collector 1a of the positive electrode 1 is connected to the sealing plate 8. A negative electrode lead 5 connected to the negative electrode 2 is connected to the battery case 9. An upper insulating plate 6 and a lower insulating plate 7 are disposed on the top and the bottom of the electrode group, respectively.

### EXAMPLES

In the following, the present invention will be specifically described based on Examples and Comparative Examples. The present invention, however, is not limited to the following Examples.

### <<Examples 1 to 10 and Comparative Examples 1 to 3>>

Lithium primary batteries each as a power storage device were produced by the following procedure.

### (Production of Positive Electrode)

As a positive electrode, 5 parts by mass of Ketjen black serving as a conductive agent, 5 parts by mass of polytetrafluoroethylene serving as a binder, and an appropriate amount of pure water were added to 100 parts by mass of electrolytic manganese dioxide, and kneaded together, to prepare a positive electrode mixture in a wet state.

Next, the positive electrode mixture was packed into a positive electrode current collector made of expanded metal made of stainless steel (SUS444) with a thickness of 0.1 mm, to prepare a positive electrode precursor. Then, the positive electrode precursor was dried, rolled using a roll press until the thickness reached 0.4 mm, and cut into a sheet of 3.5 cm long and 20 cm wide, to obtain a positive electrode. Subsequently, a portion of the packed positive electrode mixture was peeled off, and a lead made of SUS444 was resistance welded to the exposed portion of the positive electrode current collector.

### (Production of Negative Electrode)

A metal lithium foil having a thickness of 300 μm was cut into a size of 3.7 cm long and 22 cm wide, to obtain a negative electrode. A lead made of nickel was connected to the negative electrode at a predetermined point, by welding.

### (Fabrication of Electrode Group)

The positive electrode and the negative electrode were wound so as to face each other with a separator interposed therebetween, to form an electrode group. The separator used here was a microporous polypropylene film having a thickness of 25 μm.

### (Preparation of Nonaqueous Liquid Electrolyte)

PC, EC, and DME were mixed in a volume ratio of 3:2:5. In the mixed solvent, LiCF₃SO₃ was dissolved at a concentration of 0.5 mol/L, and an isocyanate component and a phenol component as shown in Table 1 were dissolved at a concentration as shown in Table 1, to prepare a nonaqueous liquid electrolyte. In Comparative Example 1, neither an isocyanate component nor a phenol component was used. In Comparative Example 2, an isocyanate component was used, and in Comparative Example 3, a phenol component was used.

### (Assembling of Power Storage Device)

The electrode group was housed in a cylindrical battery case serving as a negative electrode terminal. The battery case used here was an iron case (outer diameter 17 mm, height 45.5 mm). Next, after the nonaqueous liquid electrolyte was injected into the battery case, the opening of the battery case was closed with a metal sealing body serving as a positive electrode terminal. The other end of the positive electrode lead was connected to the sealing body, and the other end of the negative electrode lead was connected to the inner bottom surface of the battery case. In this way, power storage devices (lithium primary batteries) for test use were fabricated. The design capacity of the lithium primary batteries was 2000 mAh.

### (Evaluation)

The power storage devices immediately after assembling were subjected to, at 25° C., a constant-current discharge at 2.5 mA until the depth of discharge (DOD) reached 75%. The batteries after this discharge were placed in a −30° C. environment. Then, the batteries were discharged at a pulse current of 200 mA for 1 second, to measure a battery voltage (open-circuit voltage) V during pulse discharge. The lowest open-circuit voltage during current application for 1 second was taken as the initial output voltage in low temperature environment.

The power storage devices immediately after assembling were stored at 70° C. for 120 days. Using the power storage devices after storage at high temperature, the battery voltage (open-circuit voltage) V after pulse discharge was measured in low temperature environment in a similar manner to that for measuring the above initial output voltage. This voltage was taken as the output voltage in low temperature environment after storage at high temperature. The output voltage of each power storage device was expressed as a relative value, with the initial output voltage of the power storage device of Comparative Example 1 taken as 100.

The results are shown in Table 1. In Table 1, E1 to E10 are batteries of Examples 1 to 10, and C1 to C3 are batteries of Comparative Examples 1 to 3.

TABLE 1

| | | | | | phenol | | |
|---|---|---|---|---|---|---|---|
| | | | | | component/ | output voltage (relative value) | |
| | isocyanate component | | phenol component | | isocyanate | | after |
| | | concen- | | concen- | component | | storage |
| | | tration | | tration | (mass ratio) × | | at high |
| | kind | (mass %) | kind | (mass ppm) | 10⁻³ | initial | temperature |
| C1 | — | — | — | — | — | 100.0 | 90.1 |
| C2 | hexamethylene diisocyanate | 3 | — | — | — | 101.7 | 93.5 |
| C3 | — | — | 2,6-di-t-butyl-p-cresol | 8 | — | 95.4 | 81.6 |
| E1 | hexamethylene diisocyanate | 3 | 2,6-di-t-butyl-p-cresol | 8 | 0.2667 | 103.6 | 99.3 |
| E2 | 1,3-bis(isocyanatomethyl)cyclohexane | 3 | | 0.5 | 0.0167 | 104.1 | 99.6 |
| E3 | isophorone diisocyanate | 3 | | 0.1 | 0.0033 | 104.8 | 99.6 |
| E4 | 1,3-bis(isocyanatomethyl)cyclohexane | 3 | butyl hydroxyanisole | 0.5 | 0.0167 | 103.0 | 98.1 |
| E5 | hexamethylene diisocyanate | 0.5 | 2,6-di-t-butyl-p-cresol | 0.0 | 0.0020 | 103.1 | 98.0 |
| E6 | 1,3-bis(isocyanatomethyl)cyclohexane | 5 | | 0.1 | 0.0020 | 104.3 | 100.1 |
| E7 | isophorone diisocyanate | 10 | | 0.2 | 0.0020 | 104.5 | 99.0 |
| E8 | hexamethylene diisocyanate | 12 | | 0.4 | 0.0033 | 103.2 | 95.7 |
| E9 | hexamethylene diisocyanate | 0.2 | | 1 | 0.5000 | 102.9 | 95.9 |
| E10 | isophorone diisocyanate | 10 | | 150 | 1.5000 | 102.0 | 95.2 |

Table 1 shows that in C2 using an isocyanate component, as compared to C1 using a nonaqueous liquid electrolyte containing neither an isocyanate component nor a phenol component, the initial output voltage in low temperature environment increased by 1.7%. On the other hand, in C3 using a phenol component, as compared to C1, the initial output voltage in low temperature environment decreased by 4.6%. In other words, with a phenol component alone, the effect of increasing the output voltage in low temperature environment was not obtained, and moreover, the output voltage dropped significantly. Since the drop in output voltage due to a phenol component is significant, it can be inferred from the results of C1 to C3 that, when using a nonaqueous liquid electrolyte containing both an isocyanate component and a phenol component, the initial output voltage in low temperature environment would be lower than that in C1 containing neither of the components (to be, approximately, 100+1.7-4.6=97.1%). However, when actually using a nonaqueous liquid electrolyte containing both an isocyanate component and a phenol component, the initial output voltage in low temperature environment was 103.6% (E1), which was an improvement as compared to C1, and was an increase by as much as 6.5% as compared to the inferred value. Furthermore, the output voltage in low temperature environment after storage at high temperature also showed a tendency similar to the initial output voltage. Specifically, it can be inferred from C1 to C3 that, when using a nonaqueous liquid electrolyte containing both an isocyanate component and a phenol component, the initial output voltage in low temperature environment after storage at high temperature would be, approximately, 90.1+(93.5−90.1)+(81.6−90.1)=85%. However, actually, in E1, it was 99.3%, which was an increase by as much as 9.2% as compared to C1, and was an increase by as much as 14.3% as compared to the inferred value. Such excellent effects are considered to be resulted from the interaction between the isocyanate component and the phenol component, which produced a synergistic effect that cannot be obtained when each of them is used alone.

From the viewpoint of securing higher initial output voltage in low temperature environment, the phenol component/isocyanate component mass ratio in the nonaqueous liquid electrolyte is preferably 1×10⁻³ or less, more preferably 0.7×10⁻³ or less or 0.5×10⁻³ or less, even more preferably 0.3×10⁻³ or less (comparison between E1 and E10). From the same viewpoint, the concentration of the phenol component in the nonaqueous liquid electrolyte is preferably 30 ppm or less or 20 ppm or less, more preferably 10 ppm or less (comparison between E1 and E10).

From the viewpoint of securing higher output voltage in low temperature environment after storage at high temperature, the concentration of the isocyanate component in the nonaqueous liquid electrolyte is preferably 10 mass % or less (comparison between E7 and E8).

Furthermore, as compared to using a chain isocyanate compound, when using an isocyanate compound including a ring structure, a tendency is observed in which higher initial output voltage can be obtained in low temperature environment (comparison of E1 and E5 with E2, E3, E6 and E7).

Although, in Examples, examples in which lithium primary batteries are used as the power storage device are shown, other power storage devices (e.g. lithium-ion secondary batteries, lithium secondary batteries, lithium-ion capacitors) can be used with the same as or similar effects to the above.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

The nonaqueous liquid electrolyte of the present disclosure is useful as a nonaqueous liquid electrolyte for a power storage device. The power storage device using the nonaqueous liquid electrolyte of the present disclosure is suitably applicable, for example, as a main power source for various meters or a memory backup power source. Examples of the power storage device include lithium primary batteries, lithium-ion secondary batteries, lithium secondary batteries, and lithium-ion capacitors. The application of the nonaqueous liquid electrolyte and the power storage device, however, are not limited thereto.

### REFERENCE SIGNS LIST

1 positive electrode
1a positive electrode current collector
2 negative electrode
3 separator
4 positive electrode lead
5 negative electrode lead
6 upper insulating plate
7 lower insulating plate
8 sealing plate
9 battery case
10 power storage device

1. A nonaqueous liquid electrolyte for use in a power storage device, comprising:
a solute;
a nonaqueous solvent;
an isocyanate component; and
a phenol component.

2. The nonaqueous liquid electrolyte according to claim 1, wherein a mass ratio of the phenol component to the isocyanate component (=phenol component/isocyanate component) is 2×10⁻³ or less.

3. The nonaqueous liquid electrolyte according to claim 1, wherein a concentration of the phenol component is 10 ppm or less on a mass basis.

4. The nonaqueous liquid electrolyte according to claim 1, wherein a concentration of the isocyanate component is 10 mass % or less.

5. The nonaqueous liquid electrolyte according to claim 1, wherein the isocyanate component includes an isocyanate compound having two or more isocyanate groups.

6. The nonaqueous liquid electrolyte according to claim 1, wherein the isocyanate component includes an isocyanate compound including a ring structure.

7. The nonaqueous liquid electrolyte according to claim 1, wherein the phenol component includes a phenol compound having an aromatic ring, at least one phenolic hydroxy group directly bonded to the aromatic ring, and at least one selected from the group consisting of a hydrocarbon group and an alkoxy group each directly bonded to the aromatic ring.

8. The nonaqueous liquid electrolyte according to claim 7, wherein the phenol compound has at least an alkyl group, as the hydrocarbon group.

9. The nonaqueous liquid electrolyte according to claim 1, wherein the solute includes a lithium salt.

10. The nonaqueous liquid electrolyte according to claim 1, wherein
the power storage device is a lithium primary battery including a pair of electrodes,
one of the pair of electrodes includes at least one of metal lithium and a lithium alloy, and
the other electrode includes a positive electrode mixture containing manganese dioxide.

11. A power storage device, comprising:
a pair of electrodes; and a nonaqueous liquid electrolyte, wherein
the nonaqueous liquid electrolyte includes
a solute,
a nonaqueous solvent,
an isocyanate component, and
a phenol component.

12. The power storage device according to claim 11, wherein
one of the pair of electrodes is capable of electrochemically dissolving or releasing lithium ions, and the other electrode is capable of electrochemically depositing or absorbing lithium ions, and
the nonaqueous liquid electrolyte includes a lithium salt.

13. The power storage device according to claim 12, wherein
the one electrode contains at least one selected from the group consisting of lithium element, silicon element, and a carbonaceous material, and
the other electrode contains at least one element selected from the group consisting of manganese, nickel, and cobalt.

14. The power storage device according to claim 12, wherein
the power storage device is a lithium primary battery,
the one electrode includes at least one of metal lithium and a lithium alloy, and
the other electrode includes a positive electrode mixture containing manganese dioxide.

15. The power storage according to claim 11, wherein a mass ratio of the phenol component to the isocyanate component (=phenol component/isocyanate component) is 2×10⁻³ or less.
